(19) United States
(12) Patent Application Publication
(10) Pub. No.: US 2022/0012870 A1
(43) Pub. Date: Jan. 13, 2022

(54) GENERATING MENU INSIGHTS

(71) Applicant: Eric Breiding, Lake Worth, FL (US)

(72) Inventor: Eric Breiding, Lake Worth, FL (US)

(21) Appl. No.: 17/371,991

(22) Filed: Jul. 9, 2021

Related U.S. Application Data
(60) Provisional application No. 63/050,464, filed on Jul. 10, 2020.

(51) Int. Cl. G06T 7/00; G06K 9/00; G06K 9/62; G06K 9/32; G06F 16/58

(52) U.S. Cl. CPC G06T 7/0004; G06K 9/00624; G06K 9/6215; G06K 9/3233; G06K 9/6255; G06K 2209/01; G06K 2209/17; G06K 2209/27; G06T 2207/30128; G06T 2207/30168; G06F 16/5866

(57) ABSTRACT

A method for beverage identification includes capturing an image including at least a portion of a menu extracting information from the image, where the information includes a name of a wine, a grape variety, a region, a producer, a vintage, a price per unit, or a combination thereof, or where the information includes a name of a beer, a brewer, a hop variety, a grain variety, a price per unit, or a combination thereof, and outputting the image and the information.

### CROSS REFERENCE TO PRIOR APPLICATION

This application claims priority benefit of Provisional Application No. 63/050,464 (Docket No. 010322-19001A) filed Jul. 10, 2020, which is hereby incorporated by reference in its entirety.

### FIELD

The following disclosure relates to various methods, systems, and apparatus for generating menu insights from images of heterogeneously structured image data.

### BACKGROUND

Insight into which restaurants, bars, and other establishments (e.g. “clients” or “accounts”) are serving a particular beverage by the bottle or by the glass is important for a beverage producer, importer, or supplier to understand competing producers and to plan future production, marketing, and project development. Due to the tiered structure of the beverage industry (e.g. for alcoholic beverages like beer, wine, and liquor), the producers or importers do not sell beverages directly to the accounts. Instead, the accounts may purchase the beverages from a distributor. However, the accounts typically do not report information like by-the-bottle, by-the-glass, or special features for the beverages sold by the account to either the distributor or the producer.

Instead, sales representatives from a distributor may gather information about which accounts had by-the-bottle or by-the-glass features by collecting menus from the accounts during in-person sales calls. The sales representative may manually identify a particular beverage from the menu and may send information about the beverage (e.g. price, feature type) to the distributor.

### SUMMARY

In one embodiment, a method for beverage identification includes capturing, by an image sensor, an image including at least a portion of a menu, extracting, by a processor, information from the image, where the information includes a name of a wine, a grape variety, a region, a producer, a vintage, a price per unit, or a combination thereof, or where the information includes a name of a beer, a brewer, a hop variety, a grain variety, a price per unit, or a combination thereof, and outputting, by the processor, the image and the information.

In one embodiment, a method for beverage identification includes receiving, by a processor menu information extracted from an image including a menu, or the image and the menu information, matching, by the processor, a context to the menu information, determining, by the processor, a menu insight based on the context, and outputting, by the processor, the menu insight.

In one embodiment, system includes a memory, and a processor in communication with the memory, where the memory stores instructions that when executed are operable to cause the processor to receive an image depicting a menu, extract information from the image, match the information to an entry in a dictionary, receive one or more beverage records corresponding to the entry in the dictionary, and determine a menu insight based on the one or more beverage records.

### BRIEF DESCRIPTION OF THE DRAWINGS

Exemplary embodiments of the present invention are described herein with reference to the following drawings.

FIG. 1 illustrates an example flowchart for capturing menu images.

FIG. 2 illustrates an example flowchart for generating menu insights.

FIG. 3 illustrates an example system for generating menu insights.

FIG. 4 illustrates an example mobile device.

FIG. 5 illustrates an example server.

FIG. 6 illustrates another example system for generating menu insights.

FIG. 7 illustrates an example user interface of a mobile device.

### DETAILED DESCRIPTION

The process of identifying which beverages are featured on a menu is time consuming because the sales representative determines which beverages to record and sends information about the beverages manually to the distributor. Additionally, the process is error-prone because a beverage feature may be inadvertently unreported and because of typographical mistakes by the sales representative. Together, these obstacles prevent widespread reporting of beverage features. The result is that a producer may learn (e.g. from the distributor), at best, an incomplete and outdated view of features for their beverages and for beverages made by competing producers.

Though information may be extracted automatically from an image of a menu, such extraction faces significant challenges. For example, beverage accounts such as bars and restaurants may have low lighting, which increases image noise and reduces contrast and overall quality of the image. The problems posed by low lighting are compounded by the low quality of image sensors on mobile devices that may be used to obtain the images. Another problem is that beverage menus may be dense with information and use small fonts which may be indiscernible in low quality images.

Further, the structure of information on the menu may vary greatly between accounts. The heterogeneous or different structures of menus means that the same piece of information (e.g. a price per bottle) may be in two different locations on two different menus. For example, locations on the menu describing beverage names, features, prices, headings, and additional information may be inconsistent between menus for two beverage accounts, and may change over time for a single account as menus are updated. The information extracted from the menu images may not be in a consistent, organized, or comprehensible format, thereby increasing the difficulty of obtaining any insight from the menu images.

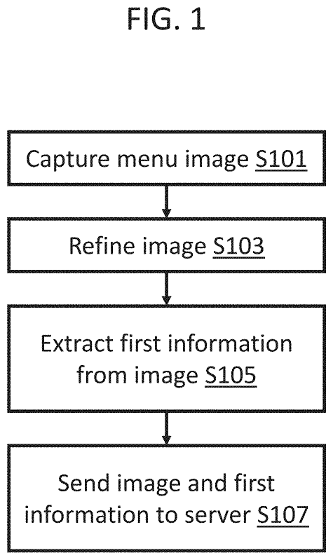

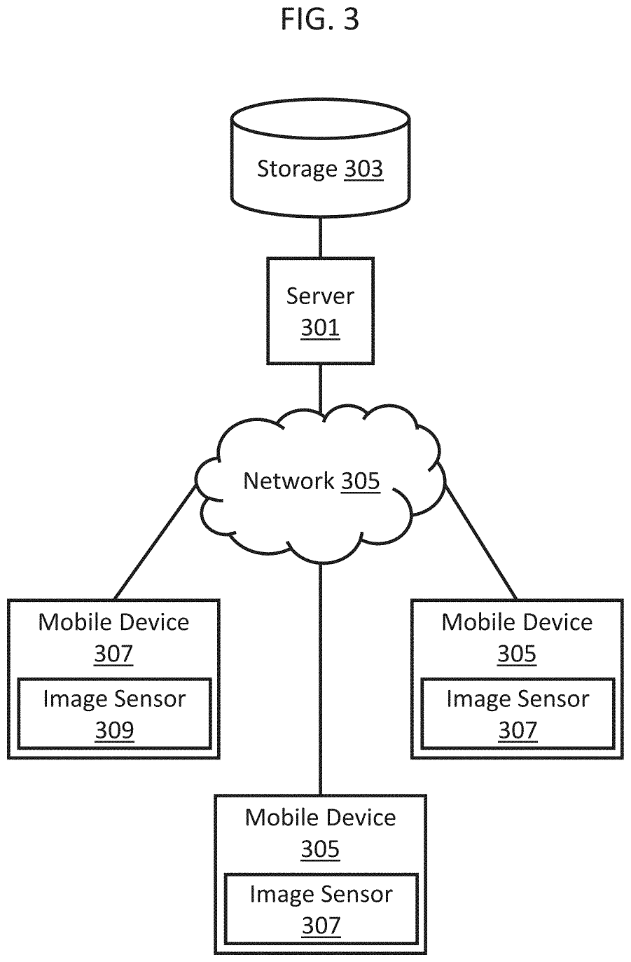

FIG. 1 illustrates an example flowchart for capturing menu images. Additional, different, or fewer acts may be provided. For example, acts S103 and S107 may not be performed. The acts of FIG. 1 may be performed by a mobile device 307, or an application on the mobile device 307, in communication with a server 301, as described with respect to FIG. 3 below.

In act S101, an image of a menu is captured. The menu image may be captured by an image sensor 309 of the mobile device 307, or by an image sensor 309 in communication with the mobile device 307. In some cases, additional information may be captured along with the menu image. For example, a time or a position of the mobile device 307 when the menu image was captured may also be recorded. The additional information may help contextualize the menu image. For example, the menu image may be linked with a beverage account based on a position of the mobile device 307 or image sensor 309. In another example, the mobile device 307 may record a date and time that the menu image is captured. The time may be used to update a user's dashboard, or to trigger an alert when the menu image is too old (e.g. after a week, a month, or another period from when the menu image was taken).

In some cases, an application on the mobile device 307 may aid in capturing the menu image. For example, the application may provide a rectangular view frame on a display of the mobile device 307 to aid a user in obtaining an aligned menu image. A preview of the image before or during capture may be displayed by the mobile device 307. In another example, the application may automatically control functions of the image sensor 309. The application may provide for automatic exposure compensation, automatic image sensor sensitivity control, and/or continuous autofocus. In this way, the application may increase the quality of the menu image, particularly for non-expert users.

In act S103, the menu image is refined. Because low image quality may negatively impact the insights gained from the menu image, the menu image may be refined before information is extracted. For example, the menu image may be panned, zoomed, and/or cropped. The refinements may be performed, selected, or initiated by a user of the mobile device 307. In some cases, the user may be prompted to select refinements. For example, a quality of the menu image may be assessed and an alert may be generated when the quality is below a threshold or target quality. In another example, the quality of information extracted from the menu image may reflect the quality of the underlying menu image. The information extracted from the menu image (e.g. extracted according to act S105) may be displayed by the mobile device 307. The user may recognize the poor quality of the extracted information (e.g. missing or incorrect characters or strings) and select the image refinements or take another menu image to improve the quality.

In act S105, information (e.g. “first information”) is extracted from the menu image. The information may be text on the menu, for example, describing one or more beverages. In this way, extracting the information transforms the menu from an image domain into a text domain. The information may be extracted using an optical character recognition (OCR) technique. By applying the OCR technique to the menu image, the menu text may be recognized and extracted. The OCR technique may use matrix matching on the menu image. The OCR may be performed using an OCR suite, such as Tesseract and/or Firebase.

In some cases, the mobile device 307 may apply the OCR technique to the menu image. In some other cases (e.g. as described below with respect to act S203), the OCR may be performed by the server 301 in communication with the mobile device 307, in addition to or instead of OCR performed by the mobile device 307.

The extracted information may include one or more strings of characters representing the menu text. The menu text may describe beverages for sale by the account. For example, the text may include a name of a wine, a wine variety, a grape variety, a wine region, a country of origin, a wine category, an alcohol percentage, a wine producer, a vintage, and/or a price per unit (e.g. per glass price, or a per bottle price). In another example, the text may include a name of a beer, a brewer, a hop variety, a grain variety, and/or a price per unit (e.g. a per glass price, or a per bottle/can price). In a further example, the text may include the above fields in reference to other beverages, such as a hard seltzer, distilled beverage, and/or soft drink. Though the extracted information from OCR contains strings of menu text, the strings may, in some cases, be matched to corresponding fields. For example, a string in the extracted text may be “Promontory,” which may be matched to a field for “winery.” The matching process is described with respect to act S205 below.

In some cases, the extracted information may include text describing multiple beverages. The extracted information may be parsed or otherwise divided into subsets of information that relate to a single beverage. In some cases, the mobile device 307 may divide the extracted information into the subsets. The extracted information, including the subsets, may be sent to the server (e.g. as described with respect to act S107). In some other cases, the extracted information is divided into subsets by the server 301.

In act S107, the menu image, the information extracted from the menu image, and/or metadata are sent to the server 301. The menu image, extracted information, and metadata may be sent from the mobile device 307 to the server 301 over a network 305. In some cases, the menu image, extracted information, and metadata may be uploaded to the server 301 as the images are obtained or the information is extracted by the mobile device 307. In some other cases, multiple menu images, information extracted from the images, and/or metadata may be stored on the mobile device 305 and uploaded to the server 301 together.

The metadata may include data about the image capture, mobile device 307, the beverage account, and other information. For example, the metadata may include a time and/or date that the image was captured. The mobile device 307 may record a timestamp when the image sensor 309 captures the menu image. In another example, the metadata may include a location of the mobile device 307 when the image is taken. For example, the mobile device 307, or positioning circuitry of the mobile device 307, may record a current or last updated location of the mobile device 307 when the menu image is captured. In some cases, the mobile device 307 or the server 301 may match the mobile device 307 location to a beverage account. For example, a beverage account may be associated with a location, and the mobile device location may be matched to the nearest beverage account. The matched beverage account may be included in the metadata. In some other cases, the mobile device 307 may accept user input specifying a beverage account identifier (e.g. an account number), a time, date, or other information. The user input may be included in the metadata. The metadata may also include an identifier of the user or of the mobile device 307.

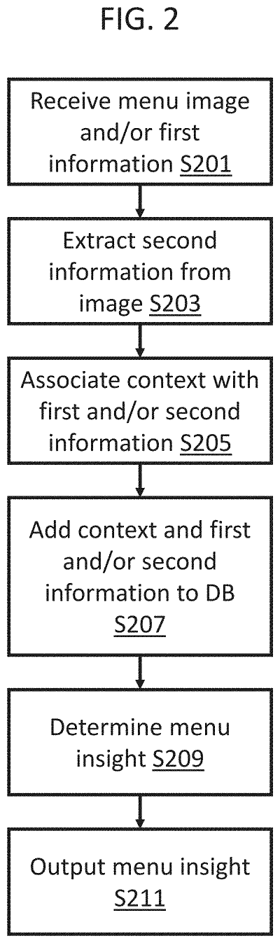

FIG. 2 illustrates an example flowchart for generating beverage menu insights. A menu insight may also be referred to as a performance insight, an aggregated image-based report, and a distributed multi-domain ontological conclusion.

Additional, different, or fewer acts may be provided. For example, act S203 may not be performed. The acts of FIG. 2 may be performed by a server 301, or an application on the server 301, in communication with a mobile device 307, as described with respect to FIG. 3 below.

In act S201, the menu image, the first information extracted from the menu image, and/or metadata are received. The server 301 may receive the menu image, the first information extracted from the menu image, and metadata from the mobile device 307. For example, the server 301 may receive the menu image, the first information extracted from the menu image, and metadata via a network 305. The server 301 may receive multiple menu images, associated first information, and metadata at one time.

In act S203, information (e.g. “second information”) is extracted from the menu image. The information may be extracted by the server 301 by applying an OCR technique to the menu image. The technique may be the same as the OCR technique used by the mobile device 307 to extract the first information, or a different technique. For example, when the mobile device 307 applied OCR on a column basis to the menu image, the server 301 may apply OCR on a row basis to the menu image. In some cases, multiple OCR techniques may be applied to the menu image.

By distributing the OCR between the mobile device 307 and the server 301, menu insights may be generated more quickly and with less expensive hardware. For example, the mobile device 307 may use lighter (e.g. less computationally intensive) character recognition techniques to extract the first information from the menu image, thereby freeing processor resources on the sever to apply heavier (e.g. more computationally intensive) character recognition techniques to extract second information from the menu image. In another example, the mobile device 307 may not perform character recognition on the menu image. Instead, the server may apply one or more character recognition techniques to the menu image to extract first and/or second information. In this way, the mobile device 307 may use less powerful hardware, thereby reducing the cost of the mobile device 307 or consuming less power. Additionally, because, in one case, only the menu image is sent to the server, less network bandwidth may be consumed in the process.

With first information extracted from the menu image with a first character recognition technique and second information extracted with a second character recognition technique, the process of obtaining insights from the menu may be more robust to differences in image quality, menu layout, and limitations of the mobile device 307 or image sensor 309. For example, the server may compare or combine the first information and the second information. In this way, errors in the first information or the second information may be corrected by the other information. A result of combining or comparing the first information and the second information may be combined information. The combined information may include text (e.g. character strings) from the first information and/or the second information.

In act S205, context is associated with or matched to the first information, the second information, and/or the combined information. The context may be associated with the information, in some cases, matching the information to one or more entries in a dictionary. An entry in the dictionary may include multiple beverage descriptors. For example, an entry may include a wine name, a grape variety, a wine region, a country of origin, a wine category, an alcohol percentage, a vintage, a list price, a bottler, a vintner, a distributor, a producer, a price per unit (e.g. price per glass, price per bottle), and/or other information. In a further example, the dictionary entries may include the above fields in reference to other beverages, such as a hard seltzer, distilled beverage, and/or soft drink. The dictionary may be an ontological knowledge model. The ontological knowledge model may represent or describe domain knowledge. In one example, the domain knowledge for a beverage may include nodes representing a producer, distributor, and accounts of the beverage.

The context may be associated with the information by determining a similarity of a subset of the information and the dictionary. For example, a subset of the information may include menu text associated with a beverage listed on the menu. The subset may be compared to entries in the dictionary and a similarity or match determined between the subset and one or more dictionary entries. In some cases, a confidence or similarity score may be determined for the subset of the information. The score may be calculated by comparing the subset of the information and a dictionary entry. The score may be calculated on a character by character basis. For example, where a subset of the information matches 8 characters of the 10 characters of a dictionary entry, a confidence score may be 80%.

The dictionary entry that is most similar or a closest match with the subset of the information may be associated with the subset. In some cases, the top (e.g. closest matching, most similar, or highest confidence scores) two, three, four, or other number of entries may be provided. Additionally or alternatively, the confidence scores of the subset of the information and the dictionary entries may be compared to a threshold value. For example, a threshold may be set at 50%, 60%, 65%, or another value. matching entries with a confidence score at or above the threshold may be provided, and entries with a confidence score below the threshold may be discarded. The process may be repeated for each subset of the information. In this way, the matching or most similar dictionary entries may form the context for the extracted information.

In one example, the context (e.g. the one or more matching dictionary entries) for the information may be reviewed by a user before being used to update the database or beverage records or to determine the menu insight. The one or more dictionary entries may be provided to a user and the user may select one or more of the dictionary entries as being the appropriate context for the information. The user selection may be received via the input device 403 of the mobile device or the input device 507 of the server.

In some cases, the context may include an account for the menu or beverage. The metadata may include a location of the mobile device 307 or image sensor 309 when the menu image is captured. The location may be compared to locations of accounts. In some cases, the accounts for the comparison may be limited to accounts serviced by the user. For example, the accounts for the comparison may be chosen based on an identifier of the user or mobile device 307 included in the metadata. The beverage account closest to the location of the mobile device 307 or image sensor 309 may be associated with the first information, the second information, and/or the combined information.

The entries in the dictionary may represent terms, names, and/or fields of interest to be identified in the text information extracted from the image (e.g. a “whitelist”). However, as part of matching the text information to context, certain words may be ignored, excluded, or removed (e.g. a “blacklist”). In some cases, menus may include text describing flavor profiles of the wine or other ancillary information. Because the ancillary information is not useful for matching the text information to the dictionary, the ancillary information may be a source of noise. Performance of the context matching may decrease when the ancillary information is included, resulting in longer processing times, higher error rates, and lower confidence in the context matched to the text information.

Examples of terms or strings of ancillary information that may be excluded or removed include: St., la, les, the, los, la, des, di, of, to, vineyard, wine, winery, vintners, ranch, villa, road, vine, vino, yin, sweet, dry, family, old, vintage, selection, county, peach, apple, strawberry, cherry, blueberry, cranberry, barrel, wild, big, and/or other terms. By removing these strings from the text information, the remaining text information may be more quickly and easily matched with dictionary entries at a greater certainty.

In act S207, the context and the first information, the second information, the combined information, the context, and/or the metadata may be added to an insight database. The database may be stored in the storage 303. By adding the information, context, and metadata to the database, a record on the database may include relevant information about a beverage and the accounts that offer the beverage for sale. As additional menus and beverages are added to the database, new records may be created for beverages or existing records may be updated. A beverage record may accumulate information from multiple accounts all listing the same beverage on their menus. By aggregating data about the accounts serving a beverage into a record, insights may be generated from the database, for example, as described with act S209 below. For example, because a beverage record may include multiple accounts, a menu insight may be based on not only a beverage offered at one account location (e.g. restaurant 1) but may include other accounts offering the beverage at locations within a predefined geographic area.

In some cases, the insight database may be an ontological model. Based on the ontological knowledge of the dictionary, the ontological model may describe or represent the geographic distribution of beverages learned from the menu images. The beverage descriptors or fields of the records may be stored in the ontological model.

In act S209, a menu insight is generated or determined. The menu insight may be generated based on the beverage records in the database. The database may be stored in the storage 303 in communication with the server 301. The menu insight may reflect the sales of a beverage over one or more criteria. The criteria may correspond to one or more fields in the beverage records.

For example, a menu insight may include a geographic dispersion of accounts that offer a beverage for sale. The menu insight may be determined based on a set of beverage records including one or more accounts offering the beverage for sale. In some cases, the menu insight may show a change over time in which accounts offer the beverage for sale. For example, where multiple menu images have been captured for an account or across multiple accounts, a change in an account offering or stopping offering a beverage may be included in the menu insight. The menu insight may include a graphical representation. For example, the menu insight may be a map.

In another example, a menu insight may include a comparison of one producer's beverages to beverages made by another producer. The menu insight may be determined based on a set of beverages records with one producer in common compared against a second set of beverage records with another producer in common. In some cases, the menu insight may be limited to a geographic area or for a time period. The beverage record may include the location of the account (or location where the menu image was captured) and the date that the menu image was captured. Beverage records may be included or excluded from the subsets based on fulfilling a geographic criterion (e.g. records having accounts within a predefined area) or a temporal criterion (e.g. records having accounts offering a beverage for sale or having a new menu uploaded between two dates, or before or after a date). For example, beverage records updated within the last quarter of a year may be included in the subset. In another example, beverage records for accounts that offered a beverage on a menu within the last year are included in the subset. In a further example, beverage records having accounts with locations within the state of Florida are included in the subset, and beverage records outside of Florida are excluded. In some other cases, the subset may be limited to records having fields with a beverage descriptor, such as a grape variety. For example, beverage records with a grape variety field of “Merlot” may be included in the subset. Beverage record fields may include other beverage descriptors, such as the name of the beverage, a grape variety, a producer, a vintner, a distributor, a vintage, a per glass price, a per bottle price, a per can price, a brewer, a hop variety, a grain variety, and/or a price per unit (e.g. a per glass price, or a per bottle/can price). In a further example, the beverage record may include the above fields in reference to other beverages, such as a hard seltzer, distilled beverage, and/or soft drink.

Beverage records may be included or excluded from the subsets based on whether the beverage record includes the specified beverage descriptor.

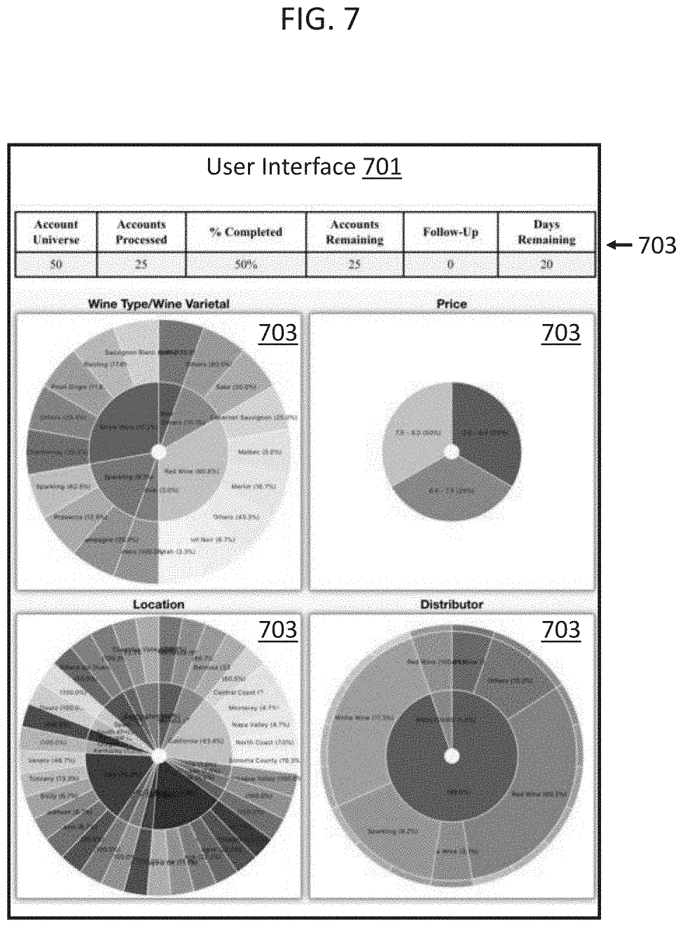

In act S211, the menu insight is output. The server 301 may output the menu insight. For example, the server 301 may display the menu insight on a display in communication with the server 301. Additionally or alternatively, the menu insight may be output to the mobile device 305. In another example, the server 301 may generate a message including the menu insight. The message may be sent to one or more users. In a further example, the menu insight is aggregated with one or more other menu insights and displayed together or included together in a message, dashboard (e.g. the interface 701 of FIG. 7), or visual display.

The menu insight provides numerous benefits. Beyond just collecting images of beverage menus, context is provided to the text extracted from the images. In this way, information from the menus of individual accounts (e.g. restaurants) may be collected to see trends across varietals, producers, distributors, time, geographic area, and other criteria (e.g. fields in the dictionary and/or beverage records). The insights may be collected to a report at an interval (e.g. daily, weekly, monthly, yearly, or over another period). In some cases, the menu insights may be viewed on a mobile device 305. For example, the user interface 701 of FIG. 7 may be viewable on the mobile device 305. Mobile device users may use the knowledge gained from the menu insights while visiting beverage accounts to assess performance. In some other cases, the knowledge gained from the menu insights may inform discussions between different parties, for example, between producers, distributors, and points of sale in a three-tier system.

FIG. 3 illustrates an example system for generating beverage menu insights. A server 301 connected to a database 303 may communicate through a network 305 with one or more mobile devices 307. The mobile devices 307 may have an image sensor 309. Additional, different, or fewer components may be included.

The server 301 may be configured to receive image data generated by image sensors 309 from the mobile devices 307 through the network 305. In some cases, the image data may be cached or collected by another device (e.g. another server or computer) before being received by the server 301. The server 301 may store the image data on the database 303. The server 301 may be configured to process the image data to determine a menu insight. For example, the server 301 may be configured to implement the method of FIG. 2.

The database 303 may be a relational database management system (RDBMS) database, non-relational (e.g. non structured query language) database, or other kind of database. The database 303 may store information including images captured by the mobile devices 307 and image sensors 309, and information extracted from the images. The database 303 may be configured to send information, such as images, information extracted from the images, and metadata, to the server 301. Information stored in the database 303 may be updated by the server 301.

The network 305 may be a wired, wireless, or combination connection between the server 301 and the mobile devices 307. The network 305 may include, for example, short range radio communications, cellular links, satellite links, and cabling. The network 305 may provide for communication between the server 301 and the mobile devices 307. Data may be sent between the server 301, the mobile devices 307, and other devices through the network 305.

The mobile devices 307 may send image data and information extracted from the image data to the server 301. In some cases, the mobile devices 307 may send metadata to the server 301. For example, the mobile devices 307 may send a location, time, and/or date at which the image was captured. The meta data may include other information about the device or a user of the device. The mobile device 307 may send the image data, extracted information, and metadata to an intermediary before the server 301. For example, the mobile device 307 may be configured to implement the method of FIG. 1.

The image sensor 309 may generate image data including one or more measurements of the image sensor 309 at a point in time. The image data may include a representation of a menu. In some cases, the image sensor 309 may be integrated with the mobile device 307. In some other cases, the image sensor 309 may be separate from, and in communication with, the mobile device 307.

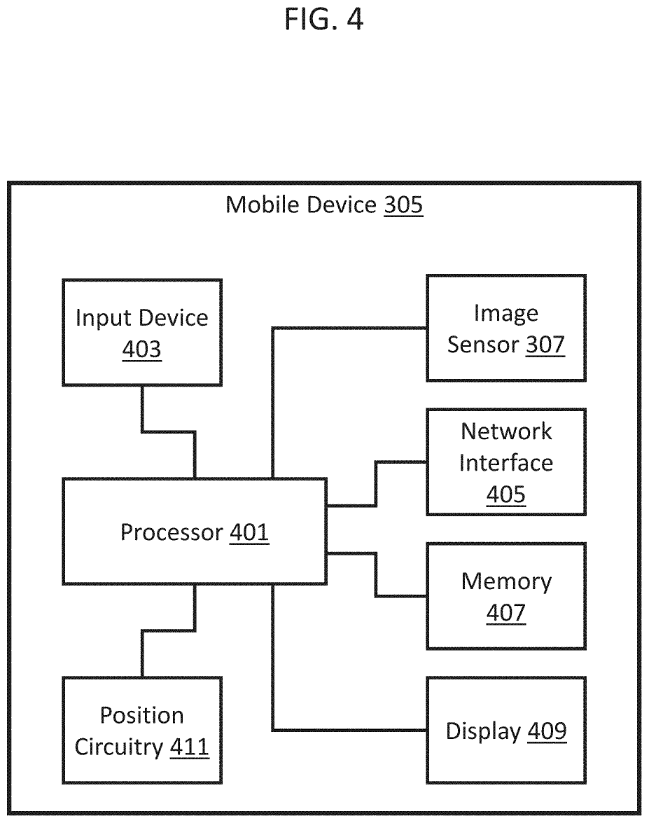

FIG. 4 illustrates an example mobile device 307. The system may include a mobile device 307, for example, as described in FIG. 3. The mobile device 307 may include an image sensor 309, a processor 401, an input device 403, a network interface 405, a memory 407, a display 409, and position circuitry 411. Different or fewer components may be present. For example, the mobile device 307 may not include position circuitry 411. In another example, the network interface is part of the communication interface 405.

The processor 401 may be a general processor or application specific integrated circuit. The processor 401 may retrieve or receive instructions stored in the memory 407 and execute the instructions.

The input device 403 may be used for interacting with the mobile device 307 or to change settings of the mobile device 307. For example, the input device 403 may be used to interact with an application of the mobile device 307, such as an image capture or account management application. The input device may be used to trigger the image sensor 309 to capture an image. In another example, the input device 403 may be used to specify a setting of the position circuitry 411. The input device 403 may be used to specify the interval at which the position circuitry measures a location of the mobile device 307. In another example, the input device 403 may be used to enter an account identifier or a user identifier. For example, the user may enter a name or number of a beverage account or beverage via the input device 403. In another example, the user may enter a personal identification number, username, or password using the input device 403. The input device 403 may be a keyboard, mouse, touchscreen, microphone, or other human-machine interface device.

The network interface 405 may provide for the exchange of information between the mobile device 307 and outside systems. For example, the network interface 405 may form a connection to one or more image sensors 309 or other sensors that are external to the mobile device 307. In another example, the network interface 405 may form a connection between the mobile device 307 and the server 301. In this way, the mobile device 307 may exchange information with sensors and systems external to the mobile device 307. For example, the mobile device 307 may receive image data from an image sensor 309 that is part of a handheld camera.

The network interface 405 may form a connection to the network 305. For example, the network interface 405 may be coupled with antennas for transmitting and receiving data. In some cases, the network interface 405 forms a connection to the network 305. In this way, the network interface 405 may allow for the exchange of data between the mobile device 307 and the server 301 or the database 303.

The memory 407 may be a volatile memory or a non-volatile memory. The memory 407 may include one or more of a read only memory (ROM), random access memory (RAM), a flash memory, an electronic erasable program read only memory (EEPROM), or other type of memory. The memory 407 may be removable from the mobile device 307, such as a secure digital (SD) memory card. The memory 407 may store instructions to cause the processor 401 to perform one or more acts. For example, the memory 407 may store instructions to perform the acts of FIG. 1. The memory may be configured to store location information from the position circuitry 411, the image sensor 309, or another sensor or circuit.

The display 409 may be a liquid crystal display (LCD) panel, light emitting diode (LED) screen, thin film transistor screen, or another type of display. An output interface of the display 409 may also include audio capabilities, or speakers. The display 409 may indicate a status or other information about the mobile device 307, the positioning circuitry 411, the image sensor 309, or a sensor in communication with the mobile device 307. The display 409 may display image information. For example, the display may show a preview of the menu image before capture (e.g. as described with respect to act S101) or during refinement (e.g. as described with respect to act S103).

The position circuitry 411 may be a positioning sensor. For example, the position circuitry may use GPS or GNSS to measure its location. In some cases, the position circuitry 411 may be remote from the mobile device 307. The position circuitry 411 may communicate with the processor 401 directly or through one or more intermediaries. For example, the position circuitry may communicate with the processor 401 of the mobile device 307 through the network interface 405. The position circuitry 411 may measure a location of the mobile device 307. In some cases, the position circuitry 411 measures the location of the mobile device 307 periodically or at a predetermined interval. For example, the location of the mobile device 307 may be measured or recorded by the position circuitry 411 when the menu image is captured. The position circuitry 411 may be configured to send the measured location to the mobile device 307, for example to the processor 401. The location information generated by the position circuitry 411 may be sent to the server 301. For example, the location information may be included in metadata sent to the server 301.

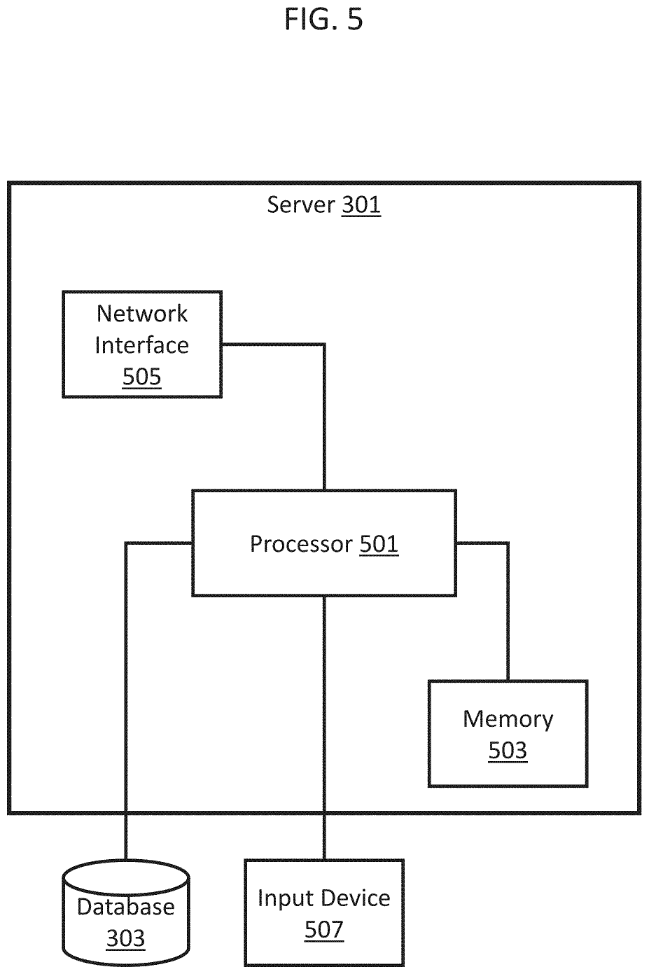

FIG. 5 illustrates an example server. The server 301 may be the server 301 of FIG. 2. The server 301 may include a processor 501, a memory 503, a communication interface 505, and an input device 507. The server 301 may be in communication with a database 303.

The processor 501 may be a general processor or application specific integrated circuit. The processor 501 may retrieve or receive instructions stored in the memory 503 and execute the instructions. For example, the processor 501 may be configured to perform the acts of FIG. 2.

The memory 503 may be a volatile memory or a non-volatile memory. The memory 503 may include one or more of a read only memory (ROM), random access memory (RAM), a flash memory, an electronic erasable program read only memory (EEPROM), or other type of memory. The memory 503 may be removable from the server 301, such as a secure digital (SD) memory card. The memory 503 may store instructions to cause the processor 501 to perform one or more acts. The memory may be configured to store location information from the position circuitry 411, the image sensor 309, or another component.

The network interface 505 may provide a connection between the server 301 and the network 305. In some cases, the network interface 505 may facilitate the receipt of the image data, extracted information, and/or metadata from the mobile device 307 or an image sensor 309.

The input device 507 may be a keyboard, terminal, or personal computer. The input device may be used to enter or modify settings of the server 301. For example, the setting may include a specification of a menu insight, a criterion for inclusion in a subset of beverage records, or a correction to extracted information, metadata, or a beverage record.

The database 303 may be directly connected to the server 301 or accessible through a network 305. For example, the server 301 may communicate with the database 303 through the network interface 505. In some cases, the database may be stored in the memory 503. The database 303 may be configured to store metadata and extracted information as beverage records.

The mobile device 307, server 301, or processors 401, 501 may include a general processor, digital signal processor, an application specific integrated circuit (ASIC), field programmable gate array (FPGA), analog circuit, digital circuit, combinations thereof, or other now known or later developed processor. The mobile device 307, server 301, or processors 401, 501 may be a single device or combinations of devices, such as associated with a network, distributed processing, or cloud computing.

The memory 407, 503 may be a volatile memory or a non-volatile memory. The memory 407, 503 may include one or more of a read only memory (ROM), random access memory (RAM), a flash memory, an electronic erasable program read only memory (EEPROM), or other type of memory. The memory 407, 503 may be removable from the mobile device 307 or server 301, such as a secure digital (SD) memory card.

The network interfaces 405, 505 may include any operable connection. An operable connection may be one in which signals, physical communications, and/or logical communications may be sent and/or received. An operable connection may include a physical interface, an electrical interface, and/or a data interface. The network interfaces 405, 505 provides for wireless and/or wired communications in any now known or later developed format.

The input device 403, 507 may be one or more buttons, keypad, keyboard, mouse, stylus pen, trackball, rocker switch, touch pad, voice recognition circuit, or other device or component for inputting data to the mobile device 307 or server 301. The input device 403, 507 and display 409 may be combined as a touch screen, which may be capacitive or resistive. The display 409 may be a liquid crystal display (LCD) panel, light emitting diode (LED) screen, thin film transistor screen, or another type of display. The output interface of the display 409 may also include audio capabilities, or speakers. In an embodiment, the input device 403, 507 may involve a device having velocity detecting abilities.

The positioning circuitry 411 may include suitable sensing devices that measure the position, traveling distance, speed, direction, and so on, of a mobile device 307. Alternatively or additionally, the mobile device 307 may include one or more detectors or sensors, such as an accelerometer and/or a magnetic sensor built or embedded into or within the interior of the mobile device 307. The accelerometer is operable to detect, recognize, or measure the rate of change of translational and/or rotational movement of the mobile device 307. The magnetic sensor, or a compass, is configured to generate data indicative of a heading of the mobile device 307. Data from the accelerometer and the magnetic sensor may indicate orientation of the mobile device 307.

The positioning circuitry 411 and/or network interface 405 may include a Global Positioning System (GPS), Global Navigation Satellite System (GLONASS), or a cellular or similar sensor for providing location data. The positioning circuitry 411 may utilize GPS-type technology, a dead reckoning-type system, cellular location, or combinations of these or other systems. The positioning circuitry 411 may include suitable sensing devices that measure the traveling distance, position, speed, direction, and so on, of the mobile device 307. The positioning circuitry 411 may also include a receiver and correlation chip to obtain a GPS or GNSS signal. The mobile device 307 may receive location data from the positioning circuitry 411. The location data indicates the location of the mobile device 307.

The positioning circuitry 411 may also include gyroscopes, accelerometers, magnetometers, or any other device for tracking or determining movement of a mobile device 307. The gyroscope is operable to detect, recognize, or measure the current orientation, or changes in orientation, of a mobile device 407. Gyroscope orientation change detection may operate as a measure of yaw, pitch, or roll of the mobile device 307.

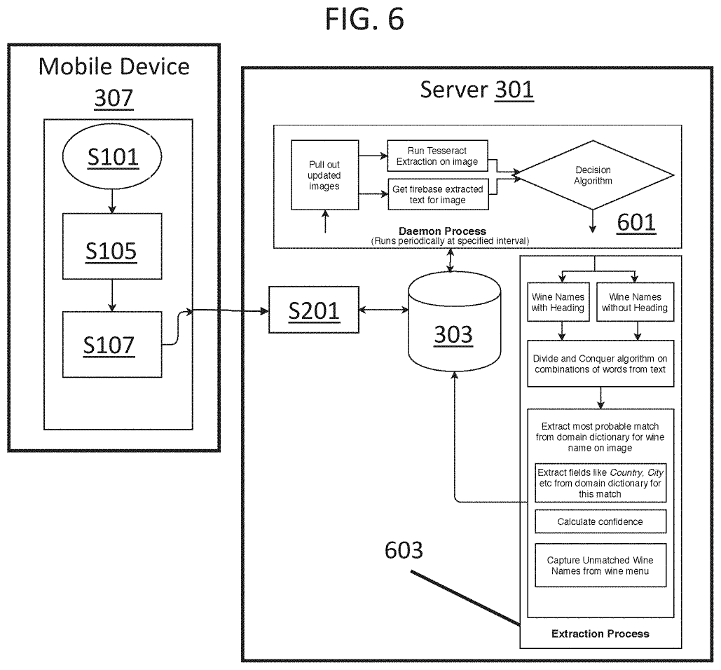

FIG. 6 illustrates another example system for generating menu insights. A server 301 may be in communication with a mobile device 307. For example, the mobile device 307 and server 301 may communicate over the network 305 shown in FIG. 3.

The mobile device 307 may be configured to run an operating system. For example, the operating system may be iOS-based or Android-based. The mobile device 307 may be configured to capture an image, extract information from the captured image, upload the image and extracted information to the server 301, and/or one or more of the acts of FIG. 1. The acts may be performed by an application executed by the mobile device 307. For example, an iOS application or an Android application may perform the acts. Information may be extracted from the captured image by or with an OCR suite. For example, the Firebase and/or or Tesseract OCR suites may be used.

The server 301 may be a cloud server. For example, the server may be a part of or hosted on a cloud platform. The cloud platform may be Amazon Web Services (AWS) or another platform. The image and extracted information may be received by the server 301 (e.g. as described with respect to act S201 of FIG. 2). For example, a Flask application running on Apache on the server 301 may receive the image and extracted information. The image and extracted information may be added to a database. For example, a database configured in MongoDB may receive and store the image and extracted information.

The image may be refined by a daemon process 601. The server 301 may perform OCR on the image. For example, the OCR may be performed with an OCR suite such as Tesseract or Firebase. The information extracted by the server 301 from the image may be compared to the information extracted from the image by the mobile device 307. For example, a decision algorithm may compare the information extracted by the mobile device 307 and the server 301 and which information, or which portions of the information may be retained, discarded, or changed.

After the decision algorithm, cleaned information may be sent to the database 303 or to an extraction process 603. The extraction process may transform the information (e.g. test strings) extracted from the image into usable data about the beverages on the menu, such as price and other properties. Headings in the information extracted from the image may be removed. The information with headings and the information without headings may be sent to a “divide and conquer” algorithm. The divide and conquer algorithm may join words or strings from the extracted information into different combinations. The combinations may be matched to entries in a domain dictionary. For example, the combinations may be matched to wine names or other information stored in the dictionary. A confidence of the match for a combination with one or more entries in the dictionary may be computed. The closest or most probable matches for the combinations based on the score may be extracted from the information. Entries such as wine name, county, city, or other information in the dictionary may be extracted as well. Any unmatched wine names (e.g. combinations representing wine names not present in the dictionary) may be captured. The unmatched wine names may be retained and used to expand the dictionary with new wines. The matching dictionary entry may be sent to the database.

FIG. 7 illustrates an example user interface 701 of a mobile device 307. The user interface 701 may be displayed on the display 409. A user may interact with the user interface 701 through the input device 403.

The user interface 701 may include one or more plots 703. The plots 703 may represent information about beverage accounts and/or information about beverages extracted from images. The user may select a plot 703 via the input device 403. Selecting a plot 703 may show a detailed view of the plot 703. For example, a selected plot 703 may expand in size on the user interface 701.

In one example, a plot 703 shows the beverage accounts serviced by a user. The user may refer to the plot 703 to determine how many accounts lack a menu image or need a follow up. When the information extracted from the menu image is added to the database, for example, the beverage account associated with the menu image may be marked as “processed” or another status. The plot 703 may be updated to reflect that a menu image for the account has been uploaded and processed.

In another example, one or more plots 703 show information about beverages extracted from the menu images obtained by the user. The plots 703 may show information about beverage type/variety, price, location, and/or distributor. For example, a plot 703 may show percentages of beverages grouped into categories and subcategories. Beverages may be grouped by production location (e.g. California, Italy, France) and divided within those groups into more specific locations, (e.g. Central Coast, Sicily, Burgundy). Other information on a per-beverage basis may be shown in the plots 703 based on the information stored in the database or dictionary.

By aggregating the information across beverage records (and based on the information collected from the menu images), the plots 703 may visually represent an insight based on beverage menus collected by the user or other users. In this way, the user may quickly and easily understand which wines are produced and distributed by which companies and are sold where in what frequency. Additionally, the user may more easily track which beverage accounts the user has already visited. Based on the information in the plots 703, the user may plan which accounts to visit or suggest to the account which beverages to list on a menu.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term ‘circuitry’ or ‘circuit’ refers to all of the following: (a)hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor receives instructions and data from a read only memory or a random-access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry. In an embodiment, a vehicle may be considered a mobile device 307, or the mobile device 307 may be integrated into a vehicle.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored. These examples may be collectively referred to as a non-transitory computer readable medium.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure.

Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments. One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

We claim:

1. A method for beverage identification comprising:
capturing, by an image sensor, an image including at least a portion of a menu;
extracting, by a processor, information from the image, wherein the information comprises a name of a wine, a grape variety, a region, a producer, a vintage, a price per unit, or a combination thereof, or wherein the information comprises a name of a beer, a brewer, a hop variety, a grain variety, a price per unit, or a combination thereof; and
outputting, by the processor, the image and the information.

2. The method of claim 1, further comprising:
capturing, by the processor, metadata with the image,
wherein the metadata comprises a date, a time, a position of a mobile device, an identifier of a user of the mobile device, an account identifier, or a combination thereof.

3. The method of claim 2, further comprising:
matching, by the processor, the image to a client identifier based on the metadata.

4. The method of claim 3, wherein the image is matched to the client identifier based on the position of the mobile device.

5. The method of claim 1, further comprising:
providing, by the processor, a view frame for a user of a mobile device,
wherein the image is captured from the view frame.

6. The method of claim 1, further comprising:
refining, by the processor, the image,
wherein refining is based on a translation, a zoom level, a crop, or a combination thereof applied to the image.

7. The method of claim 1, further comprising:
capturing, by the processor, a preliminary image; and
assessing, by the processor, a quality of the preliminary image,
wherein the image is captured when the quality of the preliminary image is below a threshold image quality.

8. A method for beverage identification comprising:
receiving, by a processor, menu information extracted from an image including at least a part of a menu, or the image and the menu information;
matching, by the processor, a context to the menu information;
determining, by the processor, a menu insight based on the context; and
outputting, by the processor, the menu insight.

9. The method of claim 8, further comprising:
receiving, by the processor, the image; and
extracting, by the processor, second menu information from the image,
wherein the context is matched based on the second menu information, and
wherein the menu insight is determined based on the second menu information.

10. The method of claim 9, wherein the menu information is extracted from the image with a first optical character recognition technique, and
wherein the second menu information is extracted from the image with a second optical character recognition technique different from the first optical character recognition technique.

11. The method of claim 8, wherein the menu information comprises a location associated with the image of the menu, and
wherein an account location of the context is matched to the location associated with the image of the menu.

12. The method of claim 11, wherein the account location of the context matched to the menu information corresponds to a second account location of one or more beverage records,
wherein the menu insight is determined based on the one or more beverage records having a second account location within a predefined geographic area, and
wherein the menu insight comprises a distribution of a beverage over the predefined geographic area.

13. The method of claim 11, wherein the context matched to the menu information comprises an account identifier,
wherein the account identifier of the context corresponds to a second account identifier of one or more beverage records, and
wherein the menu insight is determined based on the one or more beverage records having the second account identifier.

14. The method of claim 8, wherein the method further comprises:
updating, by the processor, one or more beverage records corresponding to the context based on the menu information.

15. The method of claim 14, wherein the menu information comprises a time, a date, or the time and the date associated with the image of the menu, and
wherein the menu insight is determined based on the one or more beverage records updated within a predetermined time range .

16. The method of claim 15, wherein the menu information comprises a time, date, or the time and the date associated with the image of the menu, and
wherein the menu insight comprises a distribution over time of a beverage associated with the one or beverage records.

17. The method of claim 8, wherein image including at least a part of a menu, and
wherein the menu insight is output to the mobile device.

18. The method of claim 8, wherein the context is matched based on a similarity between the menu information and a dictionary entry of the context,
wherein the dictionary entry comprises a name of a wine, a grape variety, a wine region, a country of origin, a wine category, an alcohol percentage, a vintage, a list price, a bottler, a vintner, a brewer, a distributor, a producer, a price per unit, or a combination thereof.

19. The method of claim 18, wherein the similarity comprises a confidence score based on a character by character similarity between the menu information and the dictionary entry.

20. A system comprising:
a memory; and
a processor in communication with the memory, wherein the memory stores instructions that when executed are operable to cause the processor to:
receive an image depicting a menu;
extract information from the image;
match the information to an entry in a dictionary;
receive one or more beverage records corresponding to the entry in the dictionary; and
determine a menu insight based on the one or more beverage records.
